(19) United States
(12) Patent Application Publication
(10) Pub. No.: US 2017/0302108 A1
(43) Pub. Date: Oct. 19, 2017

(54) Apparatus and Method for Remote Power and Control of Electric Loads

(71) Applicant: Sam HARTNESS, Mesquite, TX (US)

(72) Inventor: Sam HARTNESS, Mesquite, TX (US)

(21) Appl. No.: 15/133,061

(22) Filed: Apr. 19, 2016

(51) Int. Cl. H02J 13/00; H05B 37/02; H02M 7/06

(52) U.S. Cl. CPC H02J 13/0096; H02M 7/06; H05B 37/0263

(57) ABSTRACT

A system and method for controlling an electrical load are provided. A power supply converts an AC power signal to a DC power signal having a ripple voltage whose valley voltage approaches zero volts when the AC power signal crosses zero volts. A buss conducts the DC power signal. A transmitter is electrically coupled to the buss and receives electrical power from the DC power signal. The transmitter sends a command by selectively biasing one or more valley voltages of the DC power signal to a predetermined non-zero voltage. A load control system is electrically coupled to the buss and configured to receive electrical power from the DC power signal. The load control system determines a length of one or more sequences of dial pulses, which include DC power signal cycles where the valley voltage is not biased to the predetermined non-zero voltage. The load control system also generates a control signal based on the determined lengths of dial pulse sequences, where the control signal is configured to control an electric load.

### TECHNICAL FIELD

The present application relates generally to power and control of electric loads and, more specifically, to a system and method for remote power and control of electric loads.

### BACKGROUND

A power control system converts an AC power source to DC to operate one or more loads. Present systems for control have not been entirely satisfactory due to cost and complexity and presently no integrated power line carrier system provides dial control and power over a common buss.

### SUMMARY

In a first embodiment, a system for controlling an electrical load includes a power supply and a buss electrically coupled to the power supply. The power supply converts an AC power signal to a DC power signal having a ripple voltage whose valley voltage approaches zero volts when the AC power signal crosses zero volts. The buss conducts the DC power signal. The system further includes a transmitter that is electrically coupled to the buss and configured to receive electrical power from the DC power signal. The transmitter is further configured to send a command by selectively biasing one or more valley voltages of the DC power signal to a predetermined non-zero voltage. The system still further includes a load control system that is electrically coupled to the buss and configured to receive electrical power from the DC power signal. The load control system determines a length of one or more sequences of dial pulses, which include DC power signal cycles where the valley voltage is not biased to the predetermined non-zero voltage. The load control system also generates a control signal based on the determined lengths of dial pulse sequences, where the control signal is configured to control an electric load.

In a second embodiment, a method of controlling an electric load includes converting an AC power signal to a DC power signal having a ripple voltage whose valley voltage approaches zero volts when the AC power signal crosses zero volts, and conducting the DC power signal on a buss. The method also includes sending a command by selectively biasing one or more valley voltages of the DC power signal to a predetermined non-zero voltage. The method further includes controlling an electric load by generating a control signal based on determined lengths of one or more sequences of dial pulses comprising DC power signal cycles where the valley voltage is not biased to the predetermined non-zero voltage. The control signal is operable to control an electric load.

In a third embodiment, load control system configured to electrically couple to a buss and receive electrical power from a DC power signal conducted by the buss. The load control system is also configured to determine a length of one or more sequences of dial pulses comprising DC power signal cycles where the valley voltage is not biased to a predetermined non-zero voltage. The load control system is further configured to generate a control signal based on the determined lengths, where the control signal is configured to control an electric load.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a lighting system according to one embodiment of the disclosure.

FIG. 2 illustrates a full wave bridge rectifier according to one embodiment of the disclosure.

FIG. 3 illustrates a DC waveform produced by the circuit of FIG. 2.

FIG. 4 shows a keypad transmitter according to one embodiment of the disclosure.

FIG. 5 illustrates a buss composite waveform produced by the circuit of FIG. 4 according to one embodiment of the disclosure.

FIG. 6 illustrates a dial pulse detector circuit and buck regulator according to one embodiment of the disclosure.

FIG. 7 illustrates a clock generation circuit according to one embodiment of the disclosure.

FIG. 8 illustrates a logic decoder circuit according to one embodiment of the disclosure.

FIG. 9 shows a timing diagram for the logic decoder circuit of FIG. 8 according to one embodiment of the disclosure.

FIG. 10 illustrates an embodiment of the disclosure configured for contactor control of an electric motor.

### DETAILED DESCRIPTION

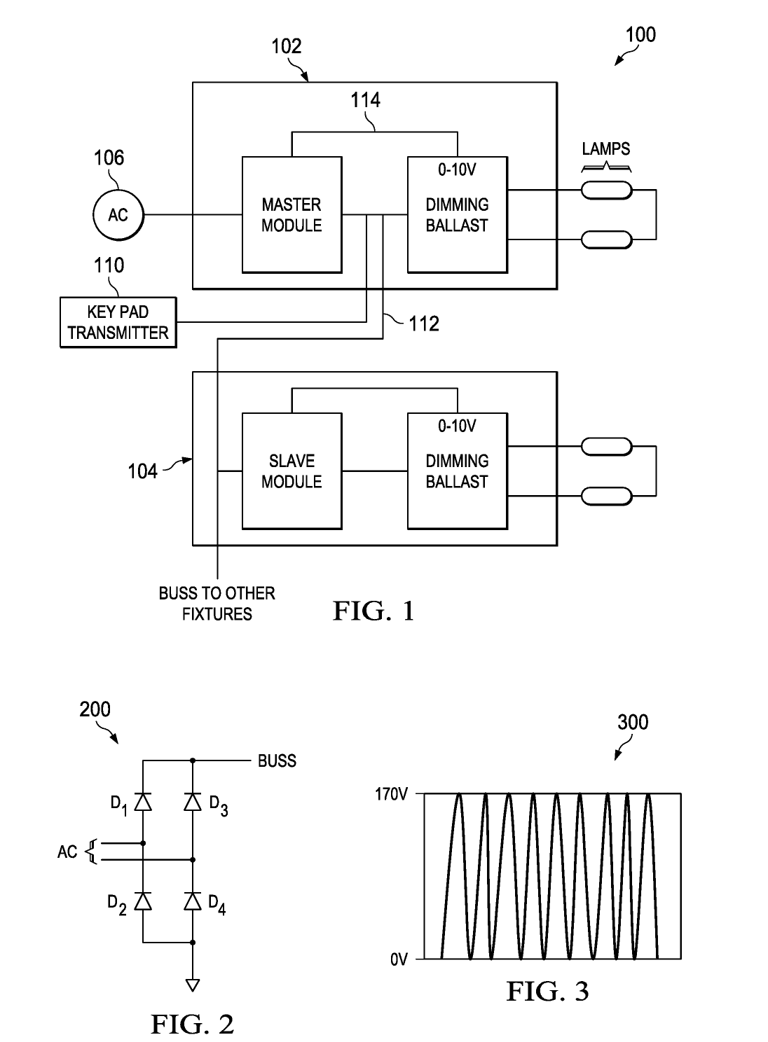

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method for remote power and control of electric loads.

A system and method of the present disclosure provide a control system that can be applied to dimming ballasts as well as other remote control systems for parallel loads. There are many commercial dimming ballasts available with no basic control systems available.

FIG. 1 illustrates a lighting system 100 according to one embodiment of the disclosure. The block diagram of FIG. 1 illustrates how the control system can be applied to dimming ballast installations, new or retrofit of systems. The system 100 includes an AC power source 106, a master lighting fixture 102, one or more slave lighting fixtures 104, a buss 112 coupling the master lighting fixture 102 to the slave lighting fixture(s) 104, and a keypad transmitter 110 coupled to the buss 112. The master lighting fixture 102 includes a master module and fluorescent lamps powered by a dimming ballast circuit. The slave lighting fixture 104 includes a slave module and fluorescent lamps powered by a dimming ballast circuit. The keypad transmitter 110 encodes onto the buss 112 control signals that control the master lighting fixture 102 and the slave lighting fixture(s) 104. The master lighting fixture 102 decodes the control signals on the buss 112 to generate a control signal 114 to control its associated dimming ballast and lamps. The slave module of the slave lighting fixture 104 operates similarly.

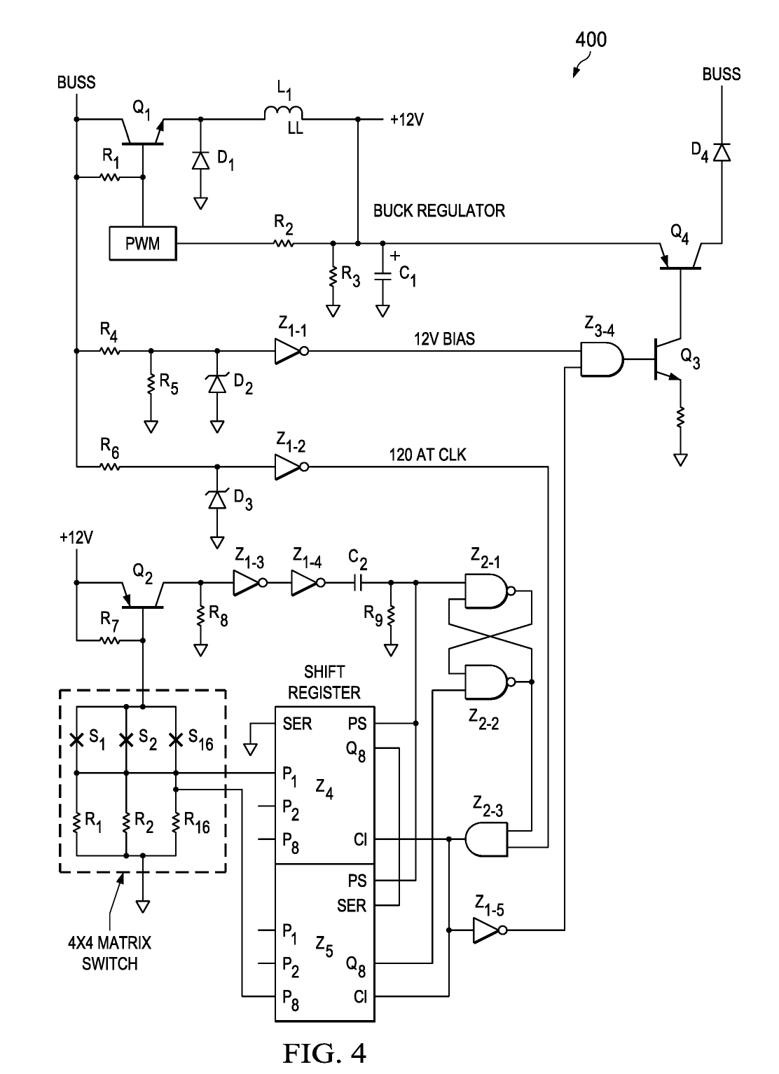

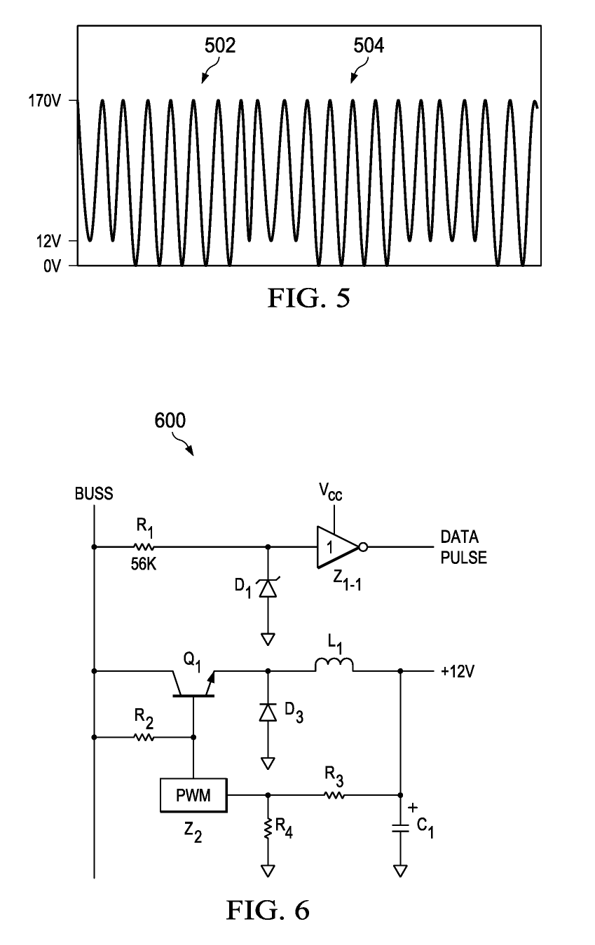

FIG. 2 illustrates a power supply 200 according to one embodiment of the disclosure. The power supply 200 is a full wave bridge rectifier that converts an AC power signal to a DC power signal to provide power to a buss that conducts the DC power signal. FIG. 3 illustrates a DC waveform 300 produced by the circuit of FIG. 2. The waveform 300 has a peak voltage of 170 volts and a 120 Hz ripple that goes to zero volts. FIG. 4 shows a keypad transmitter 400 according to one embodiment of the disclosure that selectively biases the valley voltage of the buss to 12 volts. While the disclosure teaches biasing the valley voltage of the buss to 12 volts, it will be understood that in other embodiments the valley voltage may be biased to another predetermined non-zero voltage. FIG. 5 illustrates a buss composite waveform produced by the circuit of FIG. 4 according to one embodiment of the disclosure, when the keypad sends dial pulses over the buss.

FIG. 2 is a schematic of a full wave bridge rectifier formed by diodes D₁ to D₄ that convert AC power to DC power. The DC waveform shown in FIG. 3 and produced by the circuit of FIG. 2 has a 120 Hz ripple voltage that approaches zero when the AC crosses zero. Since the valley voltage falls below 12 volts, dial pulses can be inserted in the valley as a means to send dial pulses to buss interface circuits bridged across the buss. FIG. 4 shows a keypad transmitter according to one embodiment of the disclosure that can be bridged across the buss at any point by a two wire loop that replaces a wall switch. A buck regulator is formed by Q₁, L₁, C₁, pulse width modulator, and other associated components shown in the schematic. The buck regulator converts the buss voltage to 12 v to operate the keypad transmitter and buffer amp Q₂ and Q₃.

In FIG. 4 resistors R₄ and R₅ scale the buss voltage so the CMOS gate Z1-1 functions as a threshold detector to generate 12 v drive pulses synchronized to the AC line. Resistor R₆ and diode D₃ limit the buss voltage so the gate output goes high to generate a 120 pulse-per-second (PPS) clock pulse when the buss voltage falls to 6 volts. The threshold detector generates 120 PPS clock pulses to synchronize the dial pulses to the buss voltage nulls.

The 120 PPS clock drives the shift register to generate dial pulses that inhibit the 12V bias buffered to the buss, for keypad control of the bus.

Transistor Q₁ and the discrete components (including a voltage controlled pulse width modulator) implement a buck regulator to convert the 170 v buss voltage to 12 volts for the keypad transmitter module. FIG. 5 shows the buss 170 volts goes to zero during nulls when the 12 v dial pulses inhibit the minimum voltage to 12 volts when no dial pulses are transmitted. Missing pulses are generated to the logic detector (shown in FIG. 6) when the buss voltage goes to zero.

The keypad programs a shift register to generate dial pulses that inhibit the buss being biased to 12 volts during dial pulses.

FIG. 5 shows the buss composite waveform generated when the keypad dial pulses inhibit the 12 volt bias to the buss. The first four half cycles show the ripple voltage going to zero when the logic detector of FIG. 6 generates data pulses. Dial trains of five dial pulses (502) and four dial pulses (504) may be seen in the drawing.

FIG. 1 shows how the buss is distributed to fixtures to provide power and control. The master and slave modules respond to keypad transmitters to control the ballasts. A master fixture is the same as a slave fixture except the master fixture has the diode bridge that provides power to the buss. The key pad transmitter is bridged across the buss. Lights having two or three way switching can have keypad transmitters replace any switch that has access to the buss. Any fixture that has an AC source can be converted to a master by changing a slave module to a master module.

The buss load is limited by the diode bridge and the circuit breaker. The dimming ballast is powered from the buss and is controlled by a key pad transmitter module bridged across the buss. AC provides power to the master fixture, and the master fixture buss provides power to all slave fixtures.

### Logic Decoder

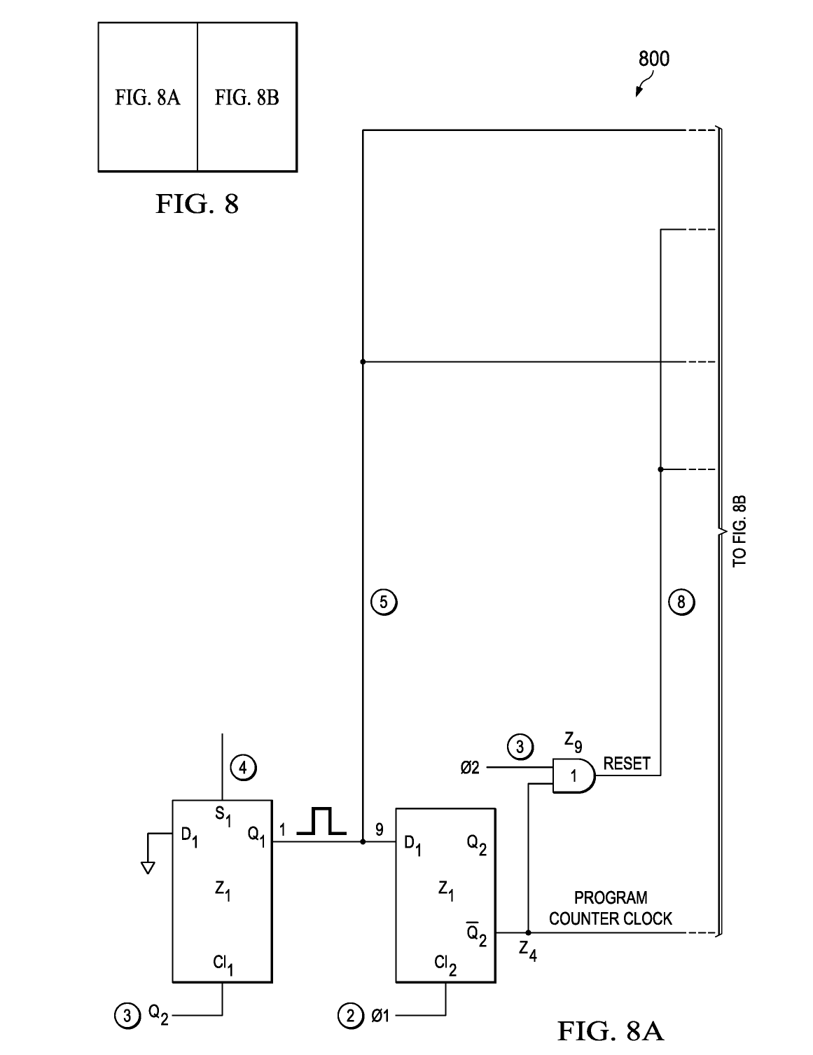

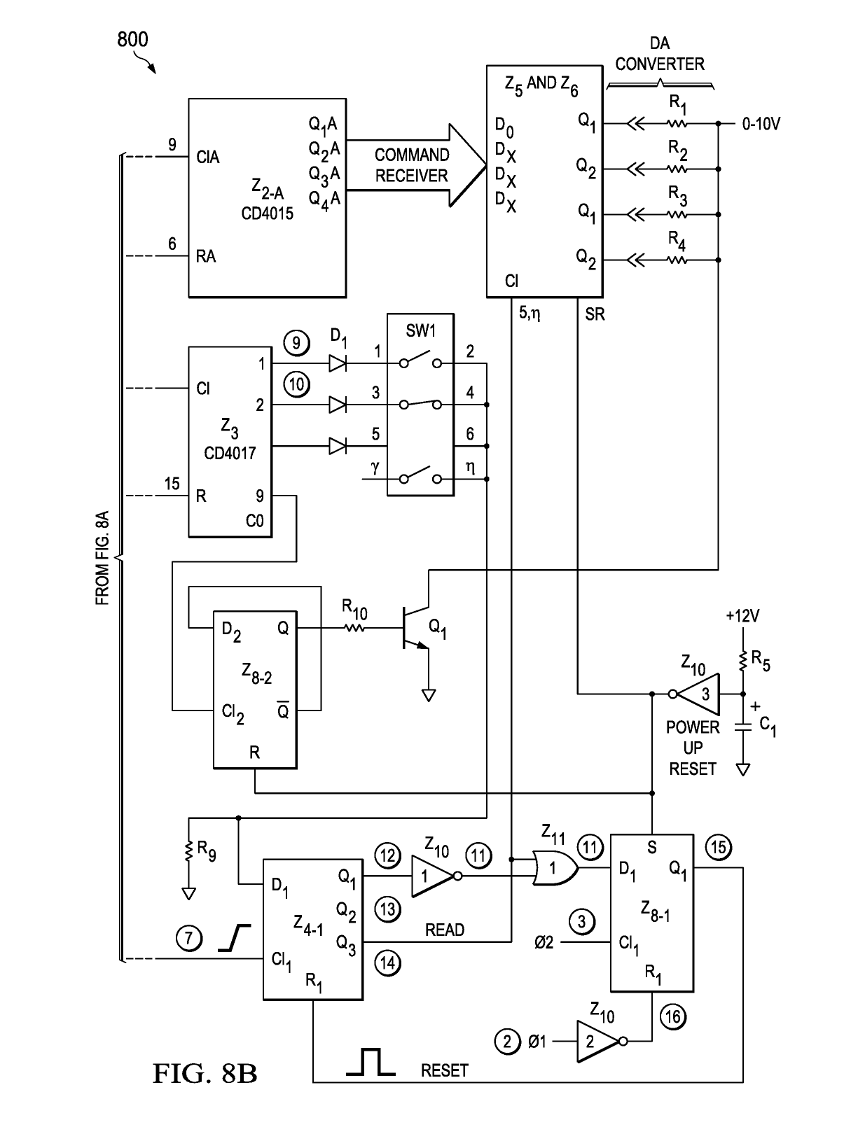

FIG. 6 illustrates a circuit 600 comprising a dial pulse detector circuit and buck regulator according to one embodiment of the disclosure. The upper portion of the circuit of FIG. 6 detects dial pulses for the logic decoders. The CMOS gate Z1-1 threshold voltage is 45% of V_{CC} so 0.45×12=5.4 volts. Zener diode D1 clamps the gate to 12 volts. When the buss voltage drops below 5.4 volts, Z1-1 output goes high to generate data pulses to the logic decoder shown in FIG. 8.

Q₁ and associated components implement a buck regulator to convert the buss voltage to 12 volts. R₂ biases Q₁ on, so current through L₁ charges C₁. The voltage is scaled by R₃ and R₄ to close the control loop. Z₂ is a voltage controlled pulse width modulator that controls Q₁ to regulate the 12 volt output for the buss interface circuit.

When the keypad transmitter is not sending dial pulses, the buss voltage is biased to 12 volts during the buss nulls. When the keypad transmitter sends dial pulses, the 12 volt bias is inhibited in the nulls so the dial pulse detector shown in FIG. 6 puts out 12 voltage data pulses when data is being sent.

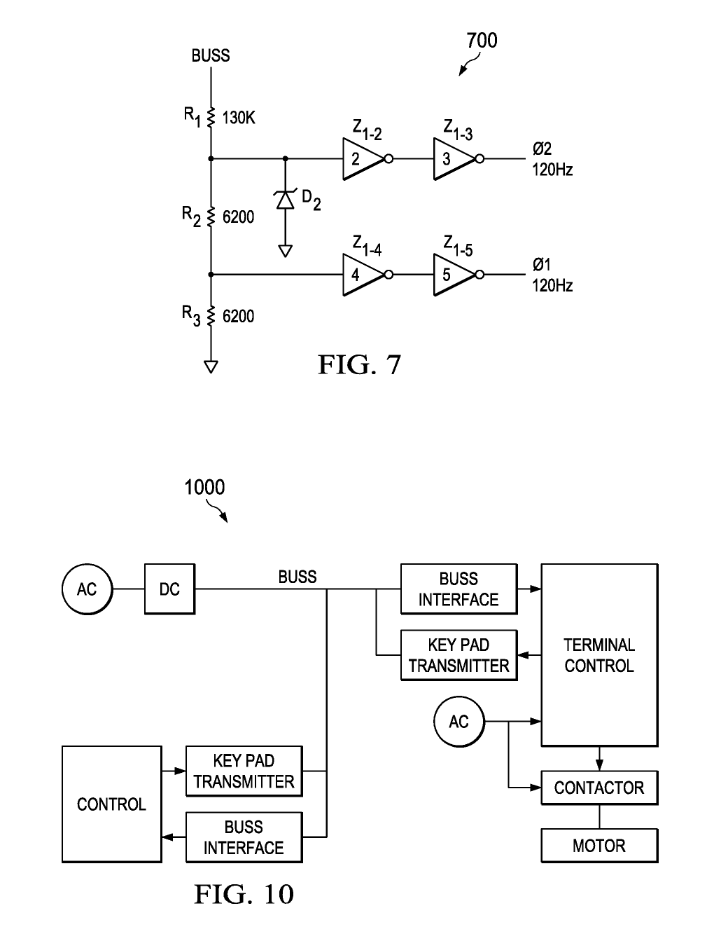

FIG. 7 illustrates a clock generation circuit 700 according to one embodiment of the disclosure. The clock generation circuit 700 generates 120 cycle Ø1 and Ø2 clocks when the buss is 60 volts and 130 volts. When R₁ drops the buss voltage to 10.8 volts, R₂ and R₃ divide the 10.8 v to 5.4 v. Z1-4 output goes high and inverted to generate Ø1 clock low. When the V_{CC} drops to 60 volts, the voltage drop to R₃ goes to 5.4 v, the gate Z1-2 output goes high and inverted to generate Ø2 clock low. When the buss voltage rises to 60 volts, Ø1 goes high and when the buss goes to 130 volts, Ø2 goes high for Ø1 and Ø2.

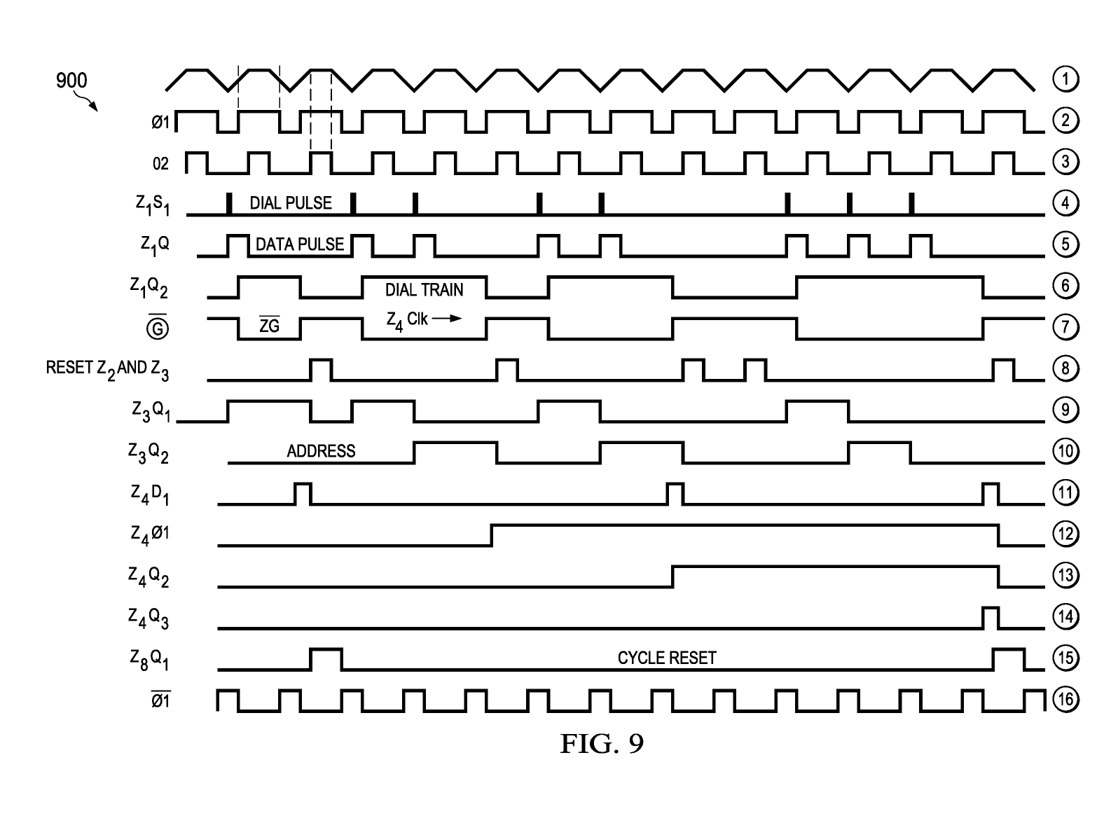

FIG. 8 illustrates a logic decoder circuit 800 according to one embodiment of the disclosure. FIG. 9 shows waveforms of various signals within the logic decoder of FIG. 8. When dial pulses are being sent by the keypad transmitter, data pulses set Z₁ S₁ so Z₁ Q₁ can clock Z2 and Z3. Z1 stretches dial pulses (4) to data pulses (5). The clock Ø2 transfers the low on Z₁ D₁ to Z₁ D₂. If a data pulse (4) comes in, it sets Z₁ Q₁ high to clock Z2 and Z3, so the next clock Ø1 transfers another high (5) into Z₁Q₂ and Q₂ remains high as long as data pulses are received.

When no data pulse is received, the clock Ø2 (3) transfers the low on Z₁ D₁ to Z₁ Q₁ and this is clocked through to Z₁ Q₂. When Z₁ Q₂ goes low, Z₁ Q̅₂ (7) goes high to enable Z4-1 so clock Ø2 (3) generates a RESET (8) to Z2 and Z3. When Z₁ Q̅₂ (7) goes high, Z₄ Cl₁ is incremented to read Z₄ D₁.

An invalid address will set Z₄ Q₁ low, so clocking the program counter Z₄ will transfer the Z₃ D₁ low to Z₃ Q₁. Z₄ Q₁ is inverted high to the OR gate to Z₈₋₁ D₁. The next clock will transfer the high on Z₈₋₁ D₁ to Z₈₋₁ Q₁ (15) and reset the program counter Z₄. Clock Ø1 (2) is inverted to reset Z₈. At turn on, the power up reset Z₁₀₋₃ sets Z₅ and Z₆, and sets Z₈₋₁, which resets Z₄₋₁. The power up reset also resets Z₈₋₂.

### Logic Decoder Portion of Dial Pulse Counter

The dial pulse counters Z2 and Z3 must not be reset before Z4. When Z₁ Q̅₂ goes high to Z₉, the clock (3) will delay the reset (8) to Z₂ and Z₃ until after they are read by Z₄. Z₃ is a counter that strobes the switch SW₁ so the switch is set to address the receiver when it is read by Z₄ D₁.

When the address counter Z₃ and the dial pulse counter Z₂ Q have been reset, the system is ready for a new cycle since an invalid address will reset the program counter Z₄.

When a valid address is received, Z₄ D₁ is set high and a high is transferred into Z₄ Q₁. The high is inverted so Z₄ D₂ is low so the next clock will not transfer a high to Z₄ Q₂ to reset the program counter Z₄. The next dial train will be a second valid address (sent to validate the address), so Z₄ D₁ is set high again. When the program counter Z₄ is clocked, the high on Z₄ D₁ will shift D₁ into Z₄ Q₁ and Q₁ will shift into Q₂. The high on Z₄ Q₁ will be inverted by the inverter so Z₈ D₁ will be low and the low transferred to Z₄ Q₁ by the clock so the program counter Z₄ will not be reset. A valid address does not recycle the system.

The third dial train is a command and when the program counter Z₄ is clocked, Z₄ Q₁ and Z₄ Q₂ are shifted to Z₄ Q₂ and Z₄ Q₃. When Q₃ goes high it clocks Z₅ and Z₆ to read the dial pulse counter Z₂. Z₅/Z₆ form a latch for the command that can be interfaced to digital or analog control systems. When Z₄ Q₃ goes high it drives the OR gate high so the next Ø2 (3) clock will transfer Z₈ Q₁ high to reset Z₄. Clock Ø1 is inverted to reset Z₈₋₁ so the cycle ends.

The latch Z₅/Z₆ output is a binary code. A resistor network implements a digital to analog converter. The digital to analog converter generates a 0-10 v analog voltage to control a dimming ballast output. In other embodiments, the binary output can be decoded to control digital systems.

Z₈₋₂ is coupled to output 9 of Z₃. When the keypad transmitter transmits a “9”, output 9 of Z₃ toggles the flip-flop Z₈₋₂ to turn the dimming ballast off by causing Q₁ to pull the 0-10 volt source to ground.

FIG. 9 shows waveforms of various signals within the logic decoder of FIG. 8.

The master module and slave module of FIG. 1 both include the dial pulse detector circuit and buck regulator circuit 600, the clock generation circuit 700, and the logic decoder circuit 800. A slave module may also be referred to as a buss interface. The master module further includes the power supply circuit 200. One or more keypad transmitters 400 may be incorporated into the master module, the slave module(s), or may be separate from both the master module and the slave module(s).

While the embodiment shown in FIG. 1 is adapted to control a dimming ballast for lamps, it will be understood that, in other embodiments (such as that shown in FIG. 10), analog or digital output from the Logic Decoder may be used to control contactors, actuators, motors, and other controllable loads. Further, while the load in FIG. 1 (dimming ballast) is powered from the buss, it will be understood that in other embodiments loads under remote control of a system according to the disclosure may be locally powered, instead, to provide remote control of power levels greater than can be served solely by the buss.

In other embodiments, a keypad transmitter or optional control can be added for two-way communication when needed for terminal equipment to send data to other stations.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A system for controlling an electric load, comprising:
a power supply, configured to convert an AC power signal to a DC power signal having a ripple voltage whose valley voltage approaches zero volts when the AC power signal crosses zero volts;
a buss, configured to conduct the DC power signal;
a transmitter, electrically coupled to the buss and configured to:
receive electrical power from the DC power signal, and
send a command by selectively biasing one or more valley voltages of the DC power signal to a predetermined non-zero voltage; and
a load control system, electrically coupled to the buss and configured to:
receive electrical power from the DC power signal,
determine a length of one or more sequences of dial pulses comprising DC power signal cycles where the valley voltage is not biased to the predetermined non-zero voltage, and
generate a control signal based on the determined lengths,
wherein the control signal is configured to control an electric load.

2. The system of claim 1, wherein the power supply comprises a full wave bridge rectifier.

3. The system of claim 2, wherein the transmitter comprises:
a threshold detector configured to generate 12 volt drive pulses synchronized to the DC power signal to bias one or more valley voltages of the DC power signal to 12 volt; and
a shift register configured to generate dial pulses in response to a keypad, where the dial pulses inhibit the 12 volt bias buffered to the buss.

4. The system of claim 2, wherein the transmitter is configured to be bridged across the buss at any point by a two wire loop.

5. The system of claim 3, wherein the load control system comprises:
a dial pulse detector circuit configured to detect dial pulses in the DC power signal; and
a logic decoder circuit configured to generate a control signal based on detected dial pulses.

6. The system of claim 5, wherein the logic decoder circuit generates the control signal based on a first sequence of drive pulses representing an address, a second sequence of drive pulses validating the address, and a third sequence of drive pulses representing the command.

7. The system of claim 5, comprising a master module and a one or more slave modules, wherein:
the master module comprises the power supply and a first load control system; and
each slave module comprises an additional load control system without a power supply.

8. The system of claim 1, wherein the control signal is one of an analog signal and a digital signal.

9. The system of claim 1, wherein the electric load is powered from the buss.

10. A method of controlling an electric load, the method comprising:
converting an AC power signal to a DC power signal having a ripple voltage whose valley voltage approaches zero volts when the AC power signal crosses zero volts;
conducting the DC power signal on a buss;
sending a command by selectively biasing one or more valley voltages of the DC power signal to a predetermined non-zero voltage; and
controlling an electric load by generating a control signal based on determined lengths of one or more sequences of dial pulses comprising DC power signal cycles where the valley voltage is not biased to the predetermined non-zero voltage, where the control signal is operable to control an electric load.

11. The method of claim 10, wherein the AC power signal is converted to a DC power signal using a full wave bridge rectifier.

12. The method of claim 11, wherein transmitting a control signal comprises:
generating 12 volt drive pulses synchronized to the DC power signal to bias one or more valley voltages of the DC power signal to 12 volt; and
generating dial pulses in response to a keypad, where the dial pulses inhibit the 12 volt bias buffered to the buss.

13. The method of claim 12, wherein controlling an electric load comprises:
detecting dial pulses in the DC power signal; and
generating a control signal based on detected dial pulses.

14. The method of claim 13, wherein generating a control signal based on detected dial pulses comprises detecting on a first sequence of drive pulses representing an address, a second sequence of drive pulses validating the address, and a third sequence of drive pulses representing the command.

15. The method of claim 13, wherein:
converting an AC power signal to a DC power signal, and controlling a first electric load are performed in a master module; and
controlling additional electric loads is performed in one or more associated slave modules.

16. The method of claim 10, wherein the control signal is one of an analog signal and a digital signal.

17. A load control system configured to:
electrically couple to a buss and receive electrical power from a DC power signal conducted by the buss;
determine a length of one or more sequences of dial pulses comprising DC power signal cycles where the valley voltage is not biased to a predetermined non-zero voltage; and
generate a control signal based on the determined lengths, wherein the control signal is configured to control an electric load.

18. The load control system of claim 17, comprising:
a dial pulse detector circuit configured to detect dial pulses in the DC power signal; and
a logic decoder circuit configured to generate a control signal based on detected dial pulses.

19. The load control system of claim 18, wherein the logic decoder circuit generates the control signal based on a first sequence of drive pulses representing an address, a second sequence of drive pulses validating the address, and a third sequence of drive pulses representing a command.

20. The load control system of claim 17, wherein the control signal is one of an analog signal and a digital signal.
